(19) United States
(12) Patent Application Publication
(10) Pub. No.: US 2015/0108144 A1
(43) Pub. Date: Apr. 23, 2015

(54) CYCLOPENTADIENE POLYMER LINER FOR PRESSURIZED FLUID TRANSPORT SYSTEMS

(71) Applicants: Francesco Nettis, London (GB); Brian E. Spencer, Sacramento, CA (US); Zachary B. Spencer, Sacramento, CA (US)

(72) Inventors: Francesco Nettis, London (GB); Brian E. Spencer, Sacramento, CA (US); Zachary B. Spencer, Sacramento, CA (US)

(73) Assignee: Blue Wave Co S.A.

(21) Appl. No.: 14/362,506

(22) PCT Filed: Dec. 5, 2011
(86) PCT No.: PCT/EP2011/071800

§ 371 Date: Dec. 18, 2014

(51) Int. Cl. F17C 1/10

(52) U.S. Cl. CPC F17C 1/10; F17C 2203/068; F17C 2221/033
USPC 220/586

(57) ABSTRACT

This invention relates to dicyclopentadiene polymer liners for systems used for the transport of fluids, in particular corrosive fluids and pressurized fluids such as compressed raw natural gas.

### FIELD

This invention relates to systems for active and passive transport of pressurized fluids wherein the system is protected from contact with the fluid by an inert cyclopentadiene polymer liner. In particular, the systems comprise pressure vessels and pipelines used for the transport of raw natural gas.

### BACKGROUND

The detrimental effects of the burning of fossil fuels on the environment are becoming more and more of a concern and have spurred great interest in alternative energy sources. While progress is being made with solar, wind, nuclear, geothermal, and other energy sources, it is quite clear that the widespread availability of economical alternate energy sources, in particular for high energy use applications, remains an elusive target. In the meantime, fossil fuels are forecast to dominate the energy market for the foreseeable future. Among the fossil fuels, natural gas is the cleanest burning and therefore the clear choice for energy production. There is, therefore, a movement afoot to supplement or supplant, as much as possible, other fossil fuels such as coal and petroleum with natural gas as the world becomes more conscious of the environmental repercussions of burning fossil fuels.

There are primarily four ways to transport natural gas from its source to a processing plant or from the processing plant to the end user: overland transport by pipeline, overland transport in pressure vessels, transport by sub-sea pipelines and marine transport in pressure vessels. The predominant material of which pipelines and pressure vessels are fabricated is metal. Recently pressure vessels made of composites, in particular polymeric composites have come to the fore as lighter weight containment vessels that have a beneficial economic effect on the transport of pressurized fluids. While both metals and composites generally work well, they each have a significant issue, metals may not be sufficiently inert to a contained fluid and composites may not be sufficiently impermeable to the fluid.

For example, raw natural gas refers to natural gas as it comes, unprocessed, directly from the well. It contains, of course, natural gas (methane) itself but also may contain liquids such as condensate, natural gasoline and liquefied petroleum gas. Water may also be present as may other gases, either in the gaseous state or dissolved in the water, such as nitrogen, carbon dioxide and hydrogen sulfide. Some of these may be reactive in their own right or may become reactive when dissolved in water, such as carbon dioxide and hydrogen sulfide, which produces an acid when dissolved in water. The acids can react with the metal of a pressure vessel or pipeline and weaken it over time to the point of failure or at least of necessitating replacement.

With regard to composites, they, by their inherent structure tend to have a somewhat porous structure. The porous structure may be sufficiently tight to be relatively impervious to fluids at ambient pressures but when confronted with pressurized fluids as in the case of compressed raw gas, they can become quite penetrable by the compressed gas.

A natural solution to the above problems is to line pressure vessels and pipelines with materials that are both impervious and inert to a contained compressed fluid such as raw gas and such has been accomplished using polymeric materials, in particular polyethylene. The problem with polyethylene and polyenes like it is that they can require rather extreme fabrication conditions when the desire is to apply a liner layer of the substance to a surface. For example, to form a polyethylene layer, curing temperatures in excess of 450° F. must be achieved. While other polymers, notably some thermoset polymers, entail much more manageable fabrication conditions such as curing temperatures that approach ambient, these polymers often lack the physical properties desirable for use in a high stress environment.

The problem then is to find a liner material that is both easy to apply and that has the physical and chemical properties to withstand the stresses imposed in the transport of pressurized fluids such as compressed raw natural gas. This invention provides a solution to this problem in the form of dicyclopentadiene polymer liners for pressurized fluid transport systems.

### SUMMARY

Thus, in one aspect, this invention relates to a system for active or passive transport of a fluid, the system comprising:

a system component comprising an outer surface that is in contact with the environment and an inner surface that defines a volumetric space, that isolates the fluid from the external environment and that is intended to come in contact with the fluid being transported; and

a liner that is contiguous to the inner surface and that isolates the inner surface from the fluid, wherein;

the liner is formed from a prepolymer formulation comprising a dicyclopentadiene polymer.

In an aspect of this invention, the dicyclopentadiene in the prepolymer formulation is at least 92% pure.

In an aspect of this invention, the prepolymer formulation further comprises a reactive ethylene monomer.

In an aspect of this invention, the reactive ethylene monomer is selected from the group consisting of alkyl norbornenes.

In an aspect of this invention, the alkyl norbornene is selected from hexyl and decyl nornbornene.

In an aspect of this invention, the system component comprises a pressure vessel for the passive transport of compressed fluids.

In an aspect of this invention, the system component comprises a pipeline for the active transport of compressed fluids.

In an aspect of this invention, the pressurized fluid is compressed natural gas.

In an aspect of this invention, the compressed natural gas is compressed raw natural gas.

### BRIEF DESCRIPTION OF THE FIGURES

The figures shown are provided for illustrative purposes only and are not intended nor should they be construed as limiting this invention in any manner whatsoever.

FIG. 1 shows various configurations of passive transport pressure vessels that can be lined as set forth herein.

FIG. 1A shows a spherical pressure vessel.

FIG. 1B shows an oblate spheroidal pressure vessel.

FIG. 1C shows a toroidal pressure vessel.

FIG. 1D shows a pressure vessel comprising a cylindrical center section with one domed end section.

FIG. 1E shows a pressure vessel comprising a cylindrical center section with two domed end sections.

### DETAILED DESCRIPTION

### Discussion

It is understood that, with regard to this description and the appended claims, any reference to any aspect of this invention made in the singular includes the plural and vice versa unless it is expressly stated or unambiguously clear from the context that such is not intended.

As used herein, any term of approximation such as, without limitation, near, about, approximately, substantially, essentially and the like, mean that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the word or phrase unmodified by the term of approximation. In general, but with the preceding discussion in mind, a numerical value herein that is modified by a word of approximation may vary from the stated value by ±10%, unless expressly stated otherwise.

As used herein, the use of “preferred,” “preferably,” or “more preferred,” and the like refers to preferences as they existed at the time of filing of this patent application.

Technical terms not expressly defined herein are deemed to carry the meaning that one skilled in the relevant art would ascribe to them.

As used herein, “contiguous” refers to two surfaces that are adjacent and that are in direct contact or that would be in direct contact were it not for an intervening layer of another material.

As used herein, a “fluid” refers to a gas, a liquid or a mixture of gas and liquid. For example, without limitation, natural gas as it is extracted from the ground and transported to a processing center is often a mixture of the gas with liquid contaminants. Such mixture would constitute a fluid for the purposes of this invention.

As used herein, “pressurized” and “compressed” are used interchangeably and simply refer to a fluid that is in an enclosed environment wherein the pressure is higher than that of the external environment.

As used herein, a “system” refers to all the interrelated elements required to transport a pressurized or compressed fluid from point A to point B. Non-limiting examples include, for instance, a ship laden with a plurality of pressure vessels, a truck carrying a pressure vessel, a railroad train that includes a railcar or railcars carrying pressure vessels and a pipeline comprising the piping itself and ancillary pressure regulating devices such as pump stations, block valve stations and the like.

As used herein a “component” of a system of this invention refers to the actual construct within the system that contains the pressurized or compressed fluid, that isolates the fluid for the external environment. A pressure vessel or a pipeline that is isolated from the external environment are examples, without limitation, of components of a system.

As used herein, “active transport” of a fluid refers to the continuous movement of a pressurized fluid from point A to point B through a stationary containment system. The most common illustration of active transport is the transport of a fluid through a pipeline.

As used herein, “passive transport” of a fluid refers to the movement of a specific volume of the fluid under pressure, often referred to as a “compressed fluid,” a common example of which is compressed natural gas (CNG) from point A to point B in a closed pressure vessel; that is, the fluid does not move independently of the vessel.

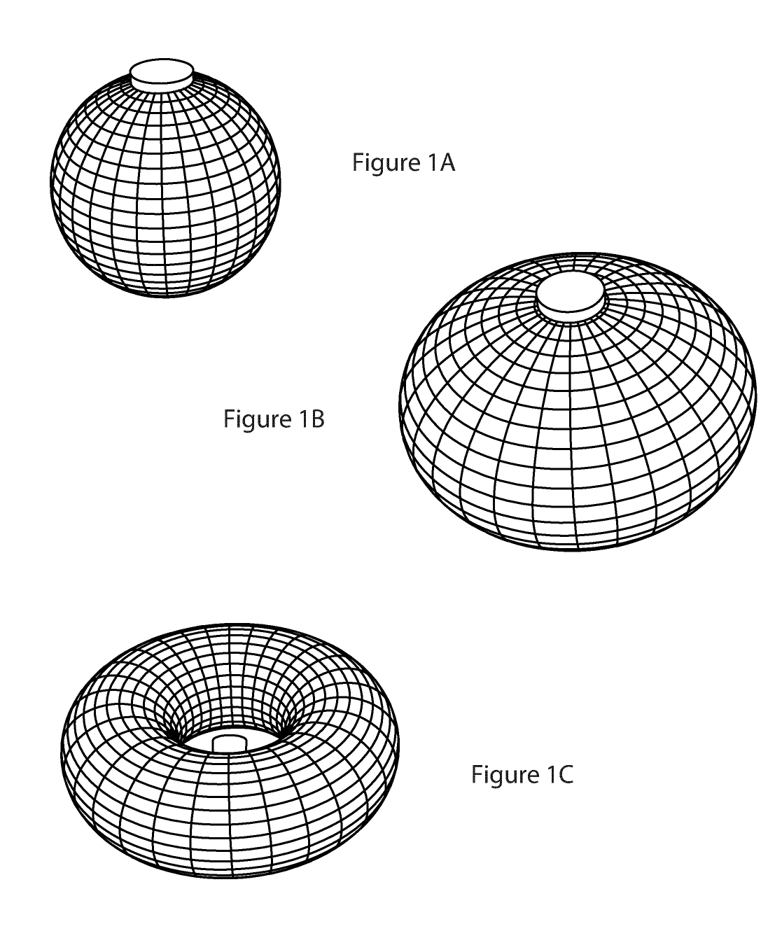

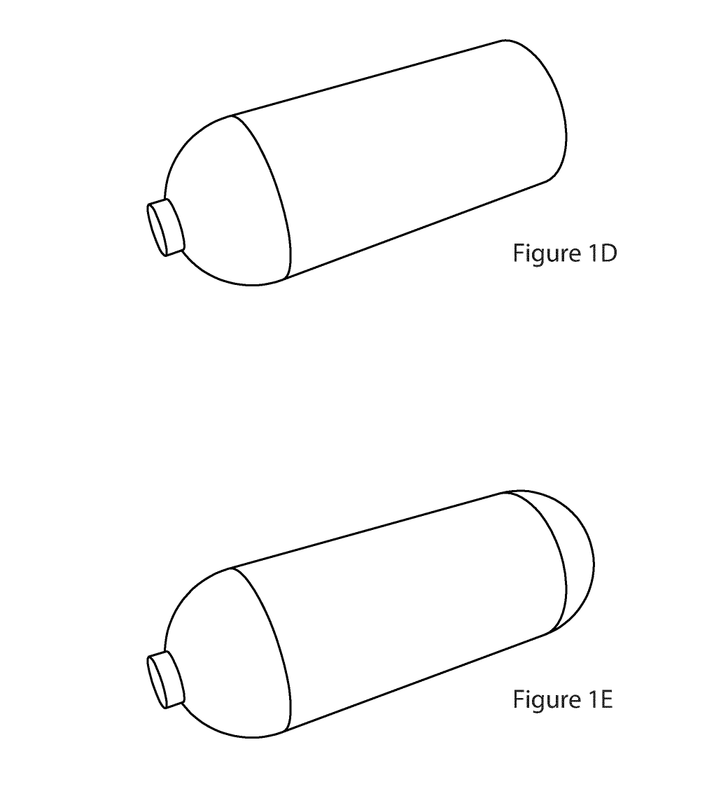

As used herein, a “pressure vessel” refers to a closed container designed to hold fluids at a pressure substantially different from ambient pressure. In particular at present, it refers to such containers used to hold and transport CNG. Pressure vessels may take a variety of shapes but most often seen in actual use are spherical, oblate spheroidal, toroidal and cylindrical center section vessels with domed end sections at either or both ends. Non-limiting illustrations of such vessel are shown in FIG. 1.

As used herein, a “pipeline” refers to the commonly recognized system for overland or off-shore transport of fluids such as oil (e.g., the Trans-Alaska and Pan-European pipelines) and gas (TransCanada PipeLines LP and the contemplated Alaskan Natural Gas Pipeline) water (Morgan-Whyalla pipeline in Western Australia). For the purpose of this invention, however, pipelines that operate under substantial internal pressure and that are used to transport substances that contain potentially corrosive components are the primary focus, although the use of novel dicyclopentadiene polymer liners of this invention for other pipeline uses is within the scope of this invention.

While polyethylene remains a suitable choice as a liner when it is pre-formed and is either loosely inserted into a vessel or used as a mandrel upon which to build an outer shell, when it is desirable to provide a liner after the fact, after a system has been built, polyethylene exhibits numerous shortcomings not the least of which is the aforementioned curing temperature. Viable alternative to polyethylene, a thermoplastic polymer are thermoset polymers, which can exhibit significantly better mechanical properties, chemical resistance, thermal stability and overall durability than the other types of polymers.

A particular advantage of most thermoset plastics or resins is that their precursor monomers or prepolymers generally tend to have relatively low viscosities under ambient conditions of pressure and temperature and therefore can be manipulated quite easily.

Another advantage of thermoset polymers is that they can usually be chemically cured isothermally, that is, at the same temperature at which they are applied to a surface.

Suitable thermoset polymers include, without limitation, epoxy polymers, polyester polymers, vinyl ester polymers, polyimide polymers, dicyclopentadiene (DCPD) polymers and combinations thereof.

Presently preferred, however, are dicyclopentadiene polymers. As used herein, a “dicyclopentadiene polymer” refers to a polymer that comprises predominantly, that is 85% or more, dicyclopentadiene monomer. The remainder of the monomer content comprises other reactive ethylene monomers.

It is also presently preferred that the dicyclopentadiene in the prepolymer formulation have a purity of at least 92%, preferably at present at least 98%.

As used herein, a “prepolymer formulation” comprises a blend prior to curing of dicyclopentadiene and one or more reactive ethylene monomer(s), a polymerization initiator or curing agent plus any other desirable additives.

As used herein, a reactive ethylene monomer refers to a small molecule that contains at least one ethylenic, i.e., —C═C—, bond that is capable of reacting with DCPD under the preferred conditions for DCPD polymerization herein and that is a flowable liquid at the desired operating temperature of the DCPD prepolymer formulation. That is, blending a selected quantity of the reactive ethylene monomer with DCPD results in a prepolymer formulation that is less viscous than the pure DCPD at the selected fabrication temperature. Therefore it is more amenable to deposition onto a surface of a component of a system to form a barrier liner for the transport of a pressurized fluid as described herein.

As alluded to previously, DCPD polymers have superior physical properties in comparison to currently used polymers for pressure vessel liners, in particular HDPE, the most common liner polymer at present. In particular, polyDCPD (pDCPD), thoe homopolymer of DCPD, is substantially less permeable to pressurized gasses such as, without limitation, CNG and hydrogen. pDCPD also exhibits far better impact resistance than HDPE. pDCPD pressure vessels also have a substantially broader operating temperature range that extends from about 0.5° K. (liquid helium) to about 120° C., whereas HDPE is limited to operational temperatures of about −40° C. to about 60° C.

Perhaps most notably, pDCPD can be cured at temperatures well below that of HDPE, that is, from about 70° F. to about 250° F. compared to 450° F. and above for HDPE. The only problem with using pDCPD at these lower temperatures is that the presently preferred DCPD monomer, which is at least 92% and more preferably 98% pure, that provides the constitutional unit of pDCPD, is a thick liquid approaching a gel-like consistency at lower, and therefore presently preferred, processing temperatures.

It is noted that, although DCPD is formally a dimer, for the purposes of this disclosure it will be referred to and treated herein as a monomer for the purposes this discussion and the appended claims. Thus, with regard to a prepolymer formulation, the “total monomer content” refers to the amount of a reactive ethylene monomer plus DCPD monomer.

Of course, if more than one reactive ethylene monomer is used, the total monomer content would include the quantity of that monomer also.

The viscosity of high purity DCPD could, of course, be adjusted by the addition of solvents but this engenders problems of its own. In the first place, the use of solvents in any system is currently discouraged for environmental, health and safety reasons. However, with regard specifically to the fabrication of pressure vessels, the eventual removal of the solvent can lead to structural defects in the resulting construct such as bubbles, pinholes and the like which could lead to untimely failure of the pressure vessel liner.

This invention circumvents these problems by diluting the DCPD with a reactive ethylene monomer, which lowers the viscosity of the prepolymer formulation to useful levels for the fabrication of system component liners as set forth herein. Further it becomes an integral part of the final copolymer so that nothing has to be removed from the cured liner.

As used herein, a reactive ethylene monomer refers to a small molecule that contains at least one ethylenic, i.e., —C═C—, bond that is capable of reacting with DCPD under the preferred conditions for DCPD polymerization herein and that is a flowable liquid at the desired operating temperature of the DCPD prepolymer formulation. That is, blending a selected quantity of the reactive ethylene monomer with DCPD results in a prepolymer formulation that is less viscous than the pure DCPD at the selected fabrication temperature. Therefore it is more amenable to application to or deposition onto a surface of a system component to form a liner thereon or to use in the formation of a composite over-wrap on a vessel liner.

Thus, in a presently preferred embodiment, a DCPD “prepolymer formulation” refers to a blend of at least 92% pure DCPD with one or more reactive ethylene monomer(s), a polymerization initiator or curing agent plus any other desirable additives prior to curing.

A key parameter that must be considered when preparing a prepolymer formulation of this invention is, of course, the desired processing temperature. By “processing temperature” is meant the temperature at which the prepolymer formulation once applied to a system for transport of pressurized fluids will be cured to provide a liner of this invention.

It is understood that, when used herein, the terms “disposed,” “applied” and “deposited” cover all manners of getting the prepolymer formulation onto or into a system herein including, without limitation, coating, spraying, painting, dipping, injection, pressure injection, vacuum assisted pressure injection and the like.

A presently preferred processing temperature is ambient or room temperature so that special temperature controlled environs can be avoided, an exceedingly beneficial objective especially when dealing with very large pressure vessels or system already on-location and unavailable for application of specialized fabrication methodologies.

Once an operating temperature is selected, a desired formulation viscosity at that temperature can be determined. The viscosity will vary depending, without limitation, on the intended thickness of the liner is being formed. The thicker the desired polymer layer, the thicker, i.e., the more viscous, the formulation may have to be.

With an operating temperature and the preferred viscosity in hand, an appropriate catalyst capable of curing the prepolymer to a polymeric final state at the selected curing temperature, which generally is the same as the selected prepolymer application or deposition temperature, can be selected. Although any known mechanism for polymerizing ethylenic monomers can be used with the prepolymer composition of this invention, the presently preferred polymerization mechanism for DCPD is ring opening metathesis polymerization (ROMP).

Useful ROMP catalysts include any standard olefin metathesis catalysts. Typical of such catalysts are, without limitation, Tebbe's reagent, a titanocene-based catalyst, Schrock tungsten, molybdenum and ruthenium catalysts and Grubbs ruthenium catalyst.

The list of possible catalysts is large and the selection of the proper catalyst will depend on the application timing and curing conditions. Application timing should be considered because polymerization may occur too fast for the selected process. The proper selection of a catalyst will avoid this problem.

It may be desirable to add a polymerization rate modifying agent to the prepolymer formulation to slow the rate. Those skilled in the art will be readily able to select an appropriate catalyst based on the disclosure herein.

Operating temperature, viscosity and catalyst having been selected, another choice to be made in preparing the prepolymer formulation is selection of the reactive ethylene monomer. While numerous reactive ethylene monomers usable with this invention will be immediately recognizable to those skilled in the art based on the disclosure herein, and while any and all such monomers are within the scope of this invention, presently preferred monomers are norbornenes, in particular, alkylnorbornenes such as, without limitation, 5-alkylnorbornenes. Most preferred at present are 5-hexyl- and 5-decyl- norbornene.

Having established a processing temperature, a viscosity and a catalyst and a reactive ethylene monomer, all that remains to be determined is how much of the reactive ethylene monomer to blend with the DCPD to achieve the desired viscosity at the selected temperature. The amount of reactive ethylene monomer is not particularly limited, the only critical factor being its effect on the physical properties of the copolymer formed. That is, the properties of pDCPD, which render it particularly useful for the fabrication of virtually any component of a pressure vessel including a liner of this invention, must not be compromised. In order to achieve this goal, it is presently preferred that the amount of reactive ethylene monomer is generally in the range of 0.1 to 10 weight percent (wt %) of the total monomer content of the prepolymer composition.

It is understood that the order of parameter and component choices above is exemplary only and is not intended nor should it be construed as limiting the scope of this invention in any manner. For example, if desired a specific reactive ethylene monomer may be the first parameter considered, etc.

As a non-limiting example of a prepolymer formulation for use at a particular operating temperature for fabrication of a particular pressure vessel component, e.g. a liner, DCPD can be blended with about 4 wt % to about 6 wt % of 5-hexylnorbornene or 5-decylnorbornene and about 0.03 to 0.0003 mol % of catMETium RF2 catalyst (Evonik Industries, Essen Germany) based on the moles of DCPD present to give a prepolymer formulation that will afford a liner with a thickness of at least 0.0125 inches.

As mentioned above, if desired, a polymerization rate modifier may be added to the prepolymer composition for the purpose, without limitation, of inhibiting polymerization during application of the prepolymer formulation to a surface of a component of a system herein. Such rate modifiers include, without limitation, triphenylphosphate.

In addition, if desired, an antioxidant may be included in the prepolymer composition. Useful antioxidants include, without limitation, hindered phenols, secondary aromatic amines, phosphites, phosphonates, dithiophosphonates and sulfur-containing organic compounds.

Other excipients that may occur to those skilled in the art as being beneficial to the formulation and/or final copolymeric composite herein may also be added to the prepolymer formulation. Prepolymer formulations containing any such added materials are within the scope of this invention.

While a pressurized transport system and liner of this invention can contain virtually any fluid so long that the PDCD polymer liner is determined to be inert to and impenetrable by the fluid, a presently preferred use of a system herein is for the containment and transport of natural gas, often in the form of “compressed natural gas” or simply “CNG,” in particular, in its direct-from-the-well form, raw gas. As mentioned above, dicyclopentadiene polymers as defined herein have excellent properties with regard to chemical resistance to the components of raw gas.

As described above, in a presently preferred embodiment of this invention, the dicyclopentadiene polymer liner herein is applied to a system used for the transport of pressurized fluids or compressed fluids. It is to be understood, however, that the liner may also be used with systems that are intended for the transport of fluids at ambient pressure, i.e., one atmosphere, wherein the dicyclopentadiene polymer liner would still exhibit beneficial properties with regard to ease of application, inertness and imperviousness.

The pressure vessels have been disclosed to be for CNG, but it might be for carrying a variety of gases, such as raw gas straight from a bore well, including raw natural gas, e.g. when compressed—raw CNG or RCNG, or H2, or CO2 or processed natural gas (methane), or raw or part processed natural gas, e.g. with CO2 allowances of up to 14% molar, H2S allowances of up to 1,000 ppm, or H2 and CO2 gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C2H6, C3H8, C4H10, C5H12, C6H14, C7H16, C8H18, C9+ hydrocarbons, CO2 and H2S, plus potentially toluene, diesel and octane in a liquid state, and other impurities/species.

The present invention has therefore been described above purely by way of example. Modifications in detail may be made to the invention within the scope of the claims appended hereto.

1. A system for active or passive transport of a fluid, the system comprising:
a system component that isolates the fluid from the external environment comprising an outer surface that is in contact with the external environment and an inner surface that defines a volumetric space in which the fluid is contained; and
a liner that is contiguous to the inner surface and that isolates the inner surface from the fluid, wherein;
the liner comprises a polymer formed from a prepolymer formulation comprising a dicyclopentadiene.

2. The system of claim 1, wherein the dicyclopentadiene in the prepolymer formulation is at least 92% pure.

3. The system of claim 2, wherein the prepolymer formulation further comprises a reactive ethylene monomer.

4. The system of claim 3, wherein the reactive ethylene monomer is selected from the group consisting of alkyl norbornenes.

5. The system of claim 4, wherein the alkyl norbornene is selected from hexyl and decyl norbornene.

6. The system of claim 1, wherein the system component comprises a pressure vessel for the passive transport of compressed fluids.

7. The system of claim 1, wherein the system component comprises a pipeline for the active transport of compressed fluids.

8. The system of claim 6, wherein the compressed fluid is compressed natural gas.

9. The system of claim 8, wherein the compressed natural gas is compressed raw natural gas.

10. The system of claim 7, wherein the compressed fluid is compressed natural gas.

11. The system of claim 10, wherein the compressed natural gas is compressed raw natural gas.

12. A method for passively transporting a fluid, comprising the system of claim 1, wherein the system component comprises a pressure vessel.

13. The method of claim 12, wherein the fluid is compressed natural gas

14. The method of claim 13, wherein the compressed natural gas is compressed raw natural gas.

15. A method for actively transporting a fluid, comprising the system of claim 1, wherein the system component comprises a pipeline.

16. The method of claim 15, wherein the fluid is natural gas.

17. The method of claim 16, wherein the natural gas is raw natural gas.

18. The method of claim 17, wherein the raw natural gas is compressed natural gas.

19. The method of claim 16, wherein the natural gas is compressed natural gas.
